(19) United States
(12) Patent Application Publication
(10) Pub. No.: US 2025/0221339 A1
(43) Pub. Date: Jul. 10, 2025

(54) Roller Conditioner System

(71) Applicant: AGCO Corporation, Duluth, GA (US)

(72) Inventor: Donald Gilles, Hesston, KS (US)

(21) Appl. No.: 19/005,290

(22) Filed: Dec. 30, 2024

Related U.S. Application Data
(60) Provisional application No. 63/618,448, filed on Jan. 8, 2024.

(51) Int. Cl. A01D 43/10; A01D 82/02

(52) U.S. Cl. CPC A01D 43/102; A01D 82/02

(57) ABSTRACT

A roller conditioner system having a frame, conditioner rollers with an upper conditioner roller and a lower conditioner roller separated by a roll gap, and a controller to control separation of the roll gap. Each end of each upper conditioner roller engages with a conditioner roller support connected to a second end of a tension member. To each end of each upper conditioner roller, the roller conditioner system has a conditioner roller adjustment mechanism with an actuator secured to the frame, a lever arm secured to a first end of the lever arm, a second end of the lever arm being mounted for rotation about a fixed pivot axis, a linkage member pivotally connected at a first end to the lever arm, and a displaceable locating element connected to the linkage member and constrained for movement between upper and lower elements of the frame of the roller conditioner system.

### CROSS-REFERENCE TO RELATED APPLICATIONS

This application claims the benefit of the filing date of U.S. Provisional Patent Application No. 63/618,448, “Roller Conditioner System,” filed Jan. 8, 2024, the entire disclosure of which is incorporated herein by reference.

### FIELD

The present invention relates to crop harvesting apparatus of the type that use rotary cutters to sever standing crops from the field and then condition the cut crop between one or more sets of upper and lower conditioning rollers before depositing the cut crop back onto the field in the form of a windrow or a swath and more particularly, it relates to a roller conditioner system for such crop harvesting apparatus and to a roller adjustment mechanism to adjust the roll gap separating the upper and lower conditioner rollers.

### BACKGROUND

Roller conditioner systems are commonly integrated into mower-conditioners to mechanically process or “condition” certain crops, such as alfalfa and other forage crops, for field wilting and drying. In contrast to impeller conditioner systems, roller conditioner systems contain one or more sets of upper and lower conditioner rollers. The conditioner rollers are separated by an adjustable “roll gap”.

Proper conditioning is a balance between optimising the desired crop quality (in order to sell the cut crop for the best economic return), throughput of the cut crop through the roller conditioner systems and the rate of crop ‘dry down’ (that is the rate at which the cut crop will lose moisture on the field before it is next processed, for example when baling occurs).

Historically, it has been left to an operator to determine this balance, for example by setting the roll gap prior to commencing operation in a field based upon prior knowledge and experience and then using this setting for the entire field without reference to changing operating environments within different regions of the field.

A number of electronic control systems for controlling the roll gap have been proposed, for example in EP 4 032 390 A1 (Deere & Company).

It is an advantage of the present invention that an improved conditioner roller adjustment mechanism is provided.

### BRIEF SUMMARY

According to a first aspect of the present invention, a roller conditioner system comprises a frame, one or more sets of conditioner rollers, each set comprising an upper conditioner roller and a lower conditioner roller separated by a roll gap through which cut crop may pass when processed by the roller conditioner system, each end of each upper conditioner roller engaging with and being supported by a conditioner roller support, each conditioner roller support providing a bearing for rotation of the upper conditioner roller, each conditioner roller support being connected to a second end of a tension member, the roller conditioner system further comprising a controller and to each end of each upper conditioner roller a conditioner roller adjustment mechanism actuated by the controller to adjust the roll gap separating each of the upper and lower conditioner rollers, each conditioner roller adjustment mechanism further comprising
an actuator secured to the frame of the roller conditioner system,
a lever arm, the actuator being secured to a first end of the lever arm, a second end of the lever arm being mounted for rotation about a fixed pivot axis,
a linkage member pivotally connected at a first end to the lever arm; and
a displaceable locating element connected at a first end to a second end of the linkage member and constrained for movement between upper and lower elements of the frame of the roller conditioner system, the displaceable locating element supporting a first end of the tension member.

Preferably, the actuator is a linear actuator.

Preferably, the first end of the lever arm is connected between the first and second ends of the linkage member.

Preferably, the upper element of the frame of the roller conditioner system comprises a guide plate.

Preferably, the lower element of the frame of the roller conditioner system comprises first and second support rollers.

Preferably, the displaceable locating element comprises a base plate having first and second triangular side walls, the base plate having an elongate opening extending between the first and second triangular side walls.

Preferably, upper surfaces of the first and second triangular side walls of the displaceable locating element support the first end of the tension member.

### BRIEF DESCRIPTION OF THE DRAWINGS

The invention will now be described, by way of example only, with reference to the accompanying drawings, in which:

FIG. 1 shows a harvesting apparatus having a roller conditioner system;

FIG. 2 shows a perspective view of elements of the roller conditioner system;

FIG. 3 shows an end view of the elements of the roller conditioner system of FIG. 2;

FIG. 4 shows a first side perspective view of certain elements of the roller adjustment mechanism;

FIG. 5 shows a second opposite perspective side view of certain elements of the roller adjustment mechanism;

FIG. 6 shows a perspective view of certain elements of the roller adjustment mechanism;

FIG. 7 shows in schematic form elements of a control system for operation of the controller; and

FIG. 8 shows a perspective view of a detail of the displaceable locating element and related elements within the roller adjustment mechanism.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Relative terms such as forward, rearward, transverse, lateral, longitudinal and sideways will be made with reference to the normal forward direction of travel of the harvesting apparatus. The terms vertical and horizontal will be made with reference to level ground upon which the harvesting apparatus is disposed. The terms “upstream” and “downstream” are made with reference to the general direction of crop flow along the material conveyance systems described.

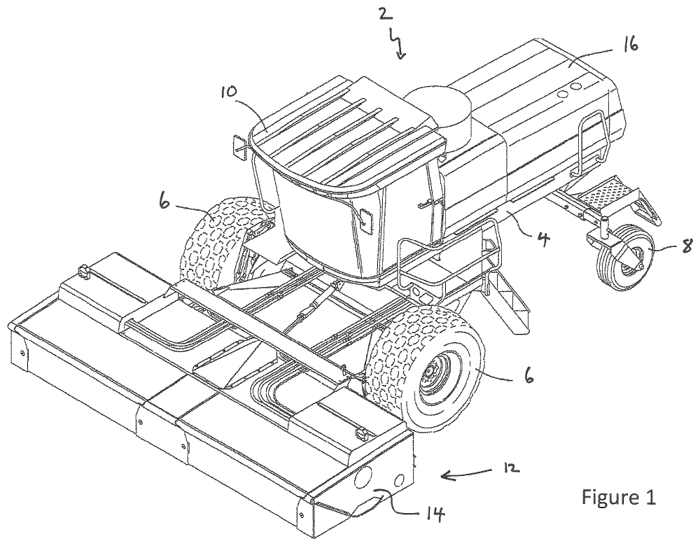

Referring first to FIG. 1, the illustrated harvesting apparatus 2 is a self-propelled windrower operable to cut standing crop in the field, condition the cut material as it moves through a roller conditioner system to improve its drying characteristics, and then return the conditioned cut crop to the field in a windrow or swath. The windrower includes a chassis or frame 4 supported by a pair of front drive wheels 6 and a pair of rear caster wheels 8 (only the left rear caster wheel being visible in FIG. 1) for movement across a field to be harvested. The frame carries a cab 10, within which an operator directs operation of the windrower, and a rearwardly spaced compartment 16 that houses a power source (not shown) such as an internal combustion engine. A harvesting header 12 is supported on the front of the frame 4 in a manner well understood by those skilled in the art.

The harvesting header 12 comprises a header frame 14 within which a rotary cutter bed (not shown) and a set of centrally disposed conditioner rollers are mounted. The rotary cutter bed extends across the front of the harvesting apparatus 2 and serves as the means by which standing crops are severed as the harvesting apparatus 2 advances across a field. The set of centrally disposed conditioner rollers are located behind the cutter bed. In the illustrated example, two pairs of cooperating conditioner rollers are shown, although alternatively, a single pair of rollers or more than two pairs of rollers could be used. The construction of such conditioner rollers is well understood by those skilled in the art.

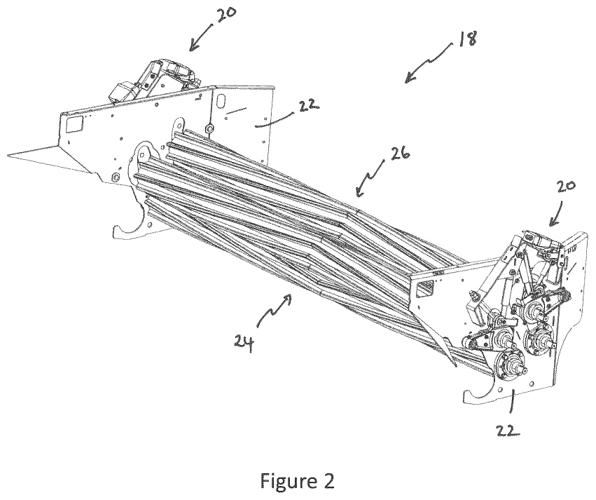

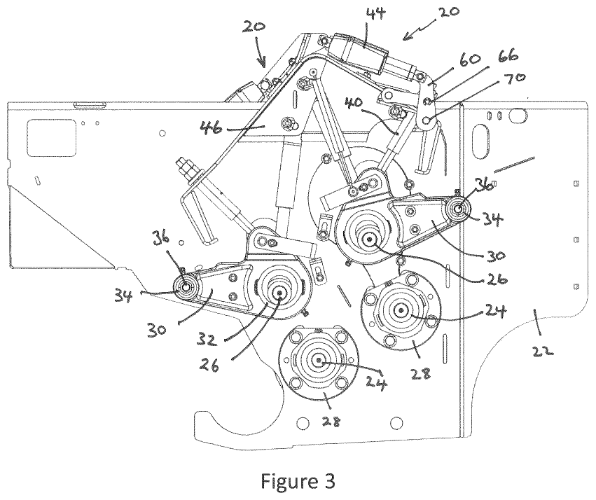

FIG. 2 illustrates a roller conditioner system 18 located within the header 12 together with at each end, conditioner roller adjustment mechanisms 20 (shown in more detail in FIGS. 3 to 6).

The structures at the left and right hand sides of the roller conditioning system 18 are reflected about a central plane of the roller conditioning system 18. As such, as context permits, only one side of the roller conditioning system 18 will be described.

As may best be seen in FIGS. 2 and 3, the structures around each of the first and second sets of conditioner rollers correspond. As such, as context permits, the structures relating to a single set of conditioner rollers will be described.

In the illustrated example, it can be seen that the conditioner rollers are mounted between first and second end panels 22. The first and second end panels 22 are themselves mounted within the header frame 14.

Lower conditioner rollers 24 are each mounted for rotation about a fixed axis in bearing housings 28 provided within the first and second end panels 22. Upper conditioner rollers 26 are suspended in and between upper conditioner roller supports 30 above the lower conditioner rollers 24 such that the axis of rotation of each of the upper conditioner rollers 26—and so the roll gap between the working surfaces of the lower conditioner rollers 26 and the upper conditioner rollers 28—can be adjusted.

Each of the upper conditioner roller supports 30 provides a bearing housing 32 in which the ends of each upper conditioner roller 26 may rotated, a second bearing 34 through which a pivot pin 36 extends to allow angular movement of the upper conditioner roller support 30 about an axis defined by the pivot pin 36, and a mounting point for a first end of a tension member 40, the tension member 40 forming part of a conditioner roller adjustment mechanism 20.

The pivot pin 36 is mounted to the adjacent end panel 22 in a suitable manner.

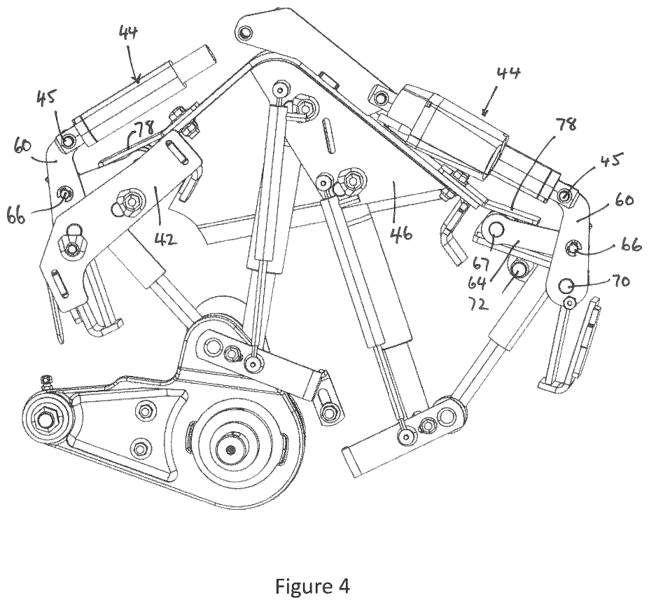

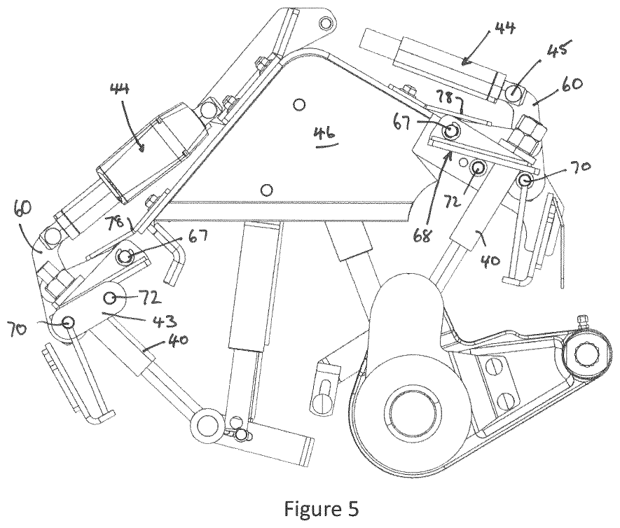

Two conditioner roller adjustment mechanisms 20 are shown in FIGS. 3, 4 and 5. It will be understood that a similar arrangement is provided at the other side of the the roller conditioner system 18. A cover plate 42 (and its securement fixings) shown on the left hand side of FIG. 4 has been omitted from the right hand side to show the underlying structure. In the reverse view shown in FIG. 5 a cover plate 43 (and its securement fixings) shown on the left hand side of FIG. 5 has been omitted from the right hand side to show the underlying structure (the cover plate 42 has also been omitted from the left hand side of FIG. 5). In the interests of clarity, elements of the roller conditioning system 18 such as one of the upper conditioner roller supports 30 have also been omitted from these FIGS.

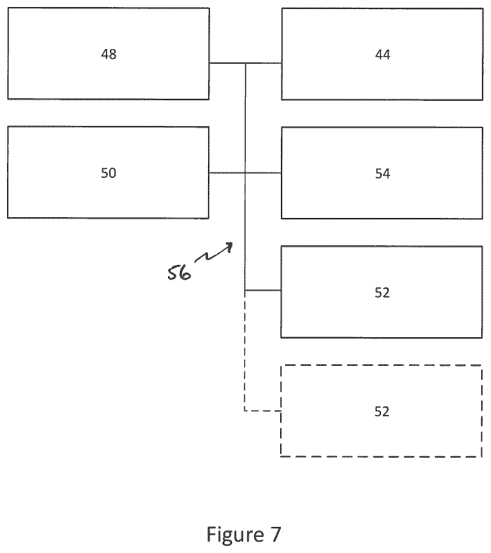

Elements of the conditioner roller adjustment mechanism 20 are best seen in FIGS. 4 to 7.

An actuator 44 is mounted to an upper part of a framework 46 provided on the end panel 22. The actuator may be secured in place in any convenient manner. The actuator 44 is in electrical communication with a controller or electronic control unit 48 over a suitable network. The electronic control unit 48 may be located on the harvesting apparatus 2 (as in the case of a self propelled windrower) or on either a towing vehicle or the harvesting apparatus (in the case of a towed harvesting apparatus). The electronic control unit 48 is provided with a memory unit 50 and is in electrical communication with a variety of sensors 52. The electronic control unit 48 is operative to receive signals from the sensors 52, process these signals in accordance with instructions provided in the memory unit 50 and issue control signals to the actuator 44 in accordance with those instructions. Additionally, or alternatively, the electronic control unit 48 is operative to receive operator instructions input into a suitable machine user interface such as a touchscreen of a user terminal 54 as user terminal signals, process these signals in accordance with instructions provided in the memory unit 50 and issue control signals to the actuator 44 in accordance with those instructions.

Conveniently the actuator 44 is a linear actuator, for example a mechanical, electro-mechanical, hydraulic or pneumatic actuator.

A first end of a lever arm 60 is pivotally connected by way of a pivot pin 45 to the actuator 44. A second end of the lever arm 60 is secured to the framework 46 for rotation about a fixed pivot axis.

A linkage element 64 connects the lever arm 60 to a displaceable locating element 68. The linkage element 64 is pivotally connected at a first end to a mid portion of the lever arm 60 by way of a pivot pin 66. Conveniently the pivot pin 66 extends through suitably sized openings in the lever arm 60 and the linkage elements 64. In a preferred example, the pivot pin 66 may be provided with grooves within which circlips may be located to retain the lever arm 60 and the linkage elements 64 in position on the pivot pin 66. The linkage element 64 is pivotally connected at a second end to a first end of the displaceable locating element 68 by way of a pivot pin 67.

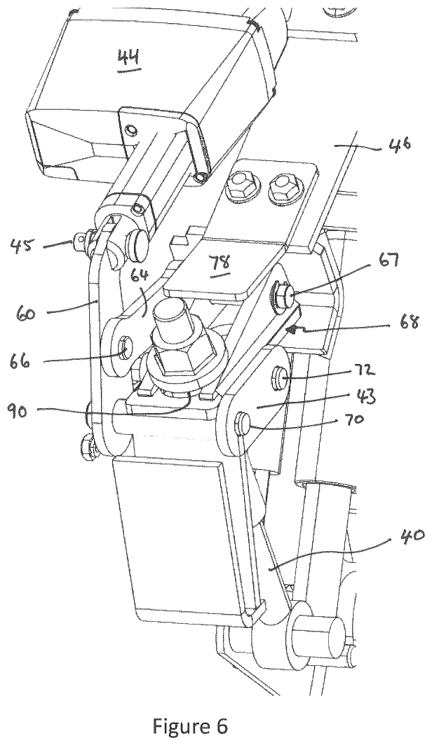

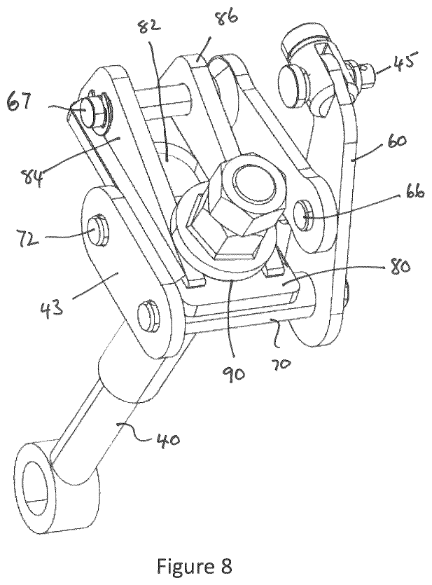

First and second supports, for example first and second rollers 70,72 are mounted within the framework 46 (FIG. 6). As best seen in FIGS. 6 and 8 the first support roller 70 extends though the cover plate 43 and serves as a pivot for the second end of the lever arm 60. An upper retaining plate 78 is also mounted to the framework 46.

The displaceable locating element 68 comprises a base plate 80 provided with an elongated opening 82. The base plate 80 is also provided with first and second upstanding triangular side plates 84,86 secured to the base plate in any suitable manner, for example by welding. The first and second triangular side plates 84,86 extend to each side of the elongate opening 82. Each of the first and second triangular side plates 84,86 is provided with a circular opening at a larger end. The pivot pin 67 extends though these circular openings and provides the pivot connection to the second end of the linkage element 64. The pivot pin 67 is conveniently provided with grooves into to which circlips may be inserted to retain the linkage element 64 and the displaceable locating element 68 in position on the pivot pin 67. As can best be seen from FIGS. 6 and 8, the displaceable locating element 68 sits atop the first and second support rollers 70,72, with upper corners of the side walls 84,86 riding against the upper retaining plate 78.

The tension member 40 extends though the elongate opening 82 of the displaceable locating element 68. A second end of the tension member is provided with an abutment surface 90, for example a surface of a washer or nut provided on the tension member, such that the abutment surface 90 of the tension member 40 rests on the upper surfaces of the first and second side walls 84,86 of the displaceable locating element 68.

In the illustrated example the roll gap is at its narrowest setting with the upper conditioner roller at its closest position to the lower conditioner roller. On receipt of a suitable signal from the electronic control unit 48, the actuator 44 is operated to move the first end of the lever arm 60 (for the right hand side roller adjustment mechanism of FIG. 4 clockwise about the pivot pin 70). This will cause the linkage element 64 to draw the displaceable locating element 68 to the right across the first and second support rollers 70,72. Thus, the displaceable locating element 68 passes under the abutment surface 90 of the tension member 40 causing the second end of the tension member 40 to ride up the inclined surfaces presented by the upper surface of the side walls 84,86 of the displaceable locating element 68 and so raise the tension member 40 relative to the illustrated position. This in turn will cause the upper conditioner roller support 30 to which the first end of the tension member 40 is connected to be rotated about the pivot pin 36 so raising the end of the upper conditioner roller 26 and so increasing the roll gap.

It will be appreciated that by sending like signals to each of the actuators (that is the actuators to the left and right hand side of each the upper conditioner roller 26) an even separation of the roll gap across the width of a conditioner roller pair can be maintained.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of square harvesting apparatus and component parts therefore and which may be used instead of or in addition to features already described herein.

What is claimed is:

1. A roller conditioner system comprises a frame, one or more sets of conditioner rollers, each set comprising an upper conditioner roller and a lower conditioner roller separated by a roll gap through which cut crop may pass when processed by the roller conditioner system, each end of each upper conditioner roller engaging with and being supported by a conditioner roller support, each conditioner roller support providing a bearing for rotation of the upper conditioner roller, each conditioner roller support being connected to a second end of a tension member, wherein to each end of each upper conditioner roller, the roller conditioner system further comprising a controller and to each end of each upper conditioner roller a conditioner roller adjustment mechanism actuated by the controller to adjust the roll gap separating each of the upper and lower conditioner rollers, each conditioner roller adjustment mechanism further comprising
an actuator secured to the frame of the roller conditioner system,
a lever arm, the actuator being secured to a first end of the lever arm, a second end of the lever arm being mounted for rotation about a fixed pivot axis,
a linkage member pivotally connected at a first end to the lever arm; and
a displaceable locating element connected at a first end to a second end of the linkage member and constrained for movement between upper and lower elements of the frame of the roller conditioner system, the displaceable locating element supporting a first end of the tension member.

2. A roller conditioner system according to claim 1, wherein in each conditioner roller adjustment mechanism, the actuator is a linear actuator.

3. A roller conditioner system according to claim 1, wherein in each conditioner roller adjustment mechanism, the first end of the lever arm is connected between the first and second ends of the linkage member.

4. A roller conditioner system according to claim 1, wherein in each conditioner roller adjustment mechanism, the upper element of the frame of the roller conditioner system comprises a guide plate.

5. A roller conditioner system according to claim 1, wherein in each conditioner roller adjustment mechanism, the lower element of the frame of the roller conditioner system comprises first and second support rollers.

6. A roller conditioner system according to claim 1, wherein in each conditioner roller adjustment mechanism, the displaceable locating element comprises a base plate having first and second triangular side walls, the base plate having an elongate opening extending between the first and second triangular side walls.

7. A roller conditioner system according to any of claim 6 wherein in each conditioner roller adjustment mechanism, upper surfaces of the first and second triangular side walls of the displaceable locating element support the first end of the tension member.
